(19) United States
(12) Patent Application Publication
(10) Pub. No.: US 2005/0284460 A1
(43) Pub. Date: Dec. 29, 2005

(54) Oven door latch lock

(75) Inventors: Robert Fitzsimons, Wolcott, CT (US); Thomas W. Spargo, Terryville, CT (US)

Correspondence Address: PILLSBURY WINTHROP SHAW PITTMAN, LLP, P.O. BOX 10500, MCLEAN, VA, 22102, US

(73) Assignee: The Stanley Works, New Britain, CT (US)

(21) Appl. No.: 11/131,191

(22) Filed: May 18, 2005

Related U.S. Application Data
(60) Provisional application No. 60/582,794, filed on Jun. 28, 2004.

(51) Int. Cl. F24C 15/00; A21B 1/00

(52) U.S. Cl. 126/19 R; 126/191

(57) ABSTRACT

An oven latch lock assembly is disclosed. The assembly includes a base for mounting the assembly to the oven, a latch operatively connected to the base at a first portion and configured to engage a door of the oven at a second portion. The latch is moveable between released and engaged positions. A bracket is operatively connected to the latch so as to effect movement of the latch between the released position and the engaged position when the bracket is rotated. A lock-out member is moveably mounted to the base and is configured to be movable between an unblocking position and a locking position. A snap-acting blade is connected to the lock-out member and snaps at a predetermined temperature to effect movement of the lock-out member. The bracket is unable to rotate when the lock-out member is in the blocking position.

### CROSS-REFERENCE TO RELATED APPLICATIONS

This application claims the benefit of priority from U.S. Provisional Patent Application No. 60/582,794, filed Jun. 28, 2004, the content of which is incorporated herein by reference in its entirety.

### BACKGROUND OF THE INVENTION

1. Field of the Invention

This invention relates generally to an oven door latch lock assembly. More particularly, this invention is directed to a manual oven door latch lock assembly for a self-cleaning oven.

2. Description of Related Art

Because self-cleaning ovens operate at high temperatures, i.e. temperatures exceeding 600° F., self-cleaning ovens have a safety lock that locks the oven door before the oven temperature reaches approximately 600° F. so that a person cannot open the door while the oven is at such high temperatures. There are currently two types of safety locks. One type uses electronics to position a latch to engage the door when a person pushes a button to put the oven in self-cleaning mode. The latch locks the door so that the door cannot be opened during the self-cleaning cycle.

The other type of lock uses a manual handle that the operator must move into the locked position before the oven can be set to self-cleaning mode. Movement of the handle causes the latch to engage the door so as to prevent the door from being opened. In order to prevent the handle from being moved to the unlocked position while the oven temperature is at the high temperature, the oven is equipped with a latch lock that does not allow a person to move the handle to the unlocked position, which would cause the latch to disengage from the door.

The typical manual latch lock has a blocking member that can be moved into a blocking relation so as to block the handle from being moved when the temperature of the oven is above a certain temperature. The blocking member is typically connected to either a bi-metal coil or a bi-metal cantilever strip that allows the member to change its position as the oven temperature changes. The bi-metal coil or strip includes two metals with different thermal properties and are arranged such that as the temperature in the oven increases, the bi-metal strip or coil moves the member towards the blocking relation with the handle.

However, such designs create a situation commonly referred to as “nuisance lockup.” Nuisance lockup is defined as the situation where the handle is moved, typically accidentally, into the locked position when the oven is at normal baking temperature, and the latch lock prevents the handle from being returned to the unlocked position until the temperature in the oven is reduced. Nuisance lockup is created because the bi-metal strips and coils are designed to move as the temperature increases. Although they do not typically move to their fully extended position until the oven temperature exceeds approximately 600° F., it is still possible for them to move enough to cause the blocking member to block the handle from being moved back to the unlocked position if the handle is accidentally moved to the locked position. Such an event can cause items in the oven to burn, as the only way to remove such items is to wait until the temperature in the oven is reduced a sufficient amount to allow the bi-metal coil or strip to move enough to allow the blocking member to move out of the way of the handle. Because ovens are thermally insulated, it may take a long period of time before the internal temperature of the oven is reduced to a level in which the bi-metal coil or strip has moved enough to unlock the latch.

### BRIEF SUMMARY OF THE INVENTION

It is one aspect of embodiments of the present invention to provide a manual oven door lock with a latch lock that does not create nuisance lockups.

It is another aspect of embodiments of the present invention to provide an oven lock assembly with fewer parts so as to make the assembly less complex, less expensive to manufacture, and more reliable.

In one embodiment, a latch lock assembly for locking a door of a self-cleaning oven is provided. The assembly includes a base for mounting the assembly to the oven. A latch is operatively connected to the base at a first portion and configured to engage the door of the oven at a second portion. The latch is moveable between a released position and an engaged position. A bracket is operatively connected to the latch so as to effect movement of the latch between the released position and the engaged position when the bracket is rotated. A lock-out member is moveably mounted to the base and configured to be movable between an unblocking position and a locking position. A snap-acting blade is connected to the lock-out member and is configured to remain in a first position when a temperature within the oven is less than a predetermined level, thereby holding the lock-out member in the unblocking position, and to snap into a second position when the temperature exceeds the predetermined level, thereby causing the lock-out member to move into the blocking position. The bracket is unable to rotate when the lock-out member is in the blocking position.

In another embodiment, a self-cleaning oven is provided. The self-cleaning oven includes a door that is hingedly mounted to a main oven assembly, and a latch lock assembly that is operatively connected to the door so as to lock the door when the oven is in self-cleaning mode. The latch lock assembly includes a base for mounting the latch lock assembly to the main oven assembly, and a latch that is operatively connected to the base at a first portion and configured to engage the door of the oven at a second portion. The latch is moveable between a released position and an engaged position. A bracket is operatively connected to the latch so as to effect movement of the latch between the released position and the engaged position when the bracket is rotated. A lock-out member is moveably mounted to the base and configured to be movable between an unblocking position and a blocking position. A snap-acting blade is connected to the lock-out member and is configured to remain in a first position when a temperature-within the oven is less than a predetermined level, thereby holding the lock-out member in the unblocking position, and to snap into a second position when the temperature exceeds the predetermined level, thereby causing the lock-out member to move into the blocking position. The bracket is unable to rotate when the lock-out member is in the blocking position.

These and other aspects of the invention will become apparent from the following detailed description when taken in conjunction with the accompanying drawings, which are part of this disclosure and which illustrate, by way of example, the principles of this invention.

### BRIEF DESCRIPTION OF THE DRAWINGS

Features of the invention are shown in the drawings, in which like reference numerals designate like elements. The drawings form part of this original disclosure, in which:

FIG. 1 is a perspective view of a self-cleaning oven of the present invention;

FIG. 2 is a perspective view of the self-cleaning oven of FIG. 1, with a door in an open position;

FIG. 3 is a top view of a latch lock assembly of the present invention in an unlocked position;

FIG. 4 is a top view of a base of the latch lock assembly of FIG. 3;

FIG. 5 is a top view of a latch of the latch lock assembly of FIG. 3;

FIG. 6 is a top view of the latch of FIG. 5 and the base of FIG. 4;

FIG. 7 is a perspective view of a bracket of the latch lock assembly of FIG. 3;

FIG. 8 is a top view of a lock of the latch lock assembly of FIG. 3;

FIG. 9 is a top view of the lock of FIG. 3, with the latch in a locked position;

FIG. 10 is a top view of the latch lock assembly of FIG. 3, with the latch in the locked position;

FIG. 11 is a top view of the lock of FIG. 9, with the lock in a locked position;

FIG. 12 is a side view of a snap-acting blade of the lock of FIG. 8;

FIG. 13 is a top view of an embodiment of a lock-out member of the lock of FIG. 8; and

FIG. 14 is a top view of the lock of FIG. 8 when the temperature of the oven is at a predetermined temperature.

### DETAILED DESCRIPTION OF THE INVENTION

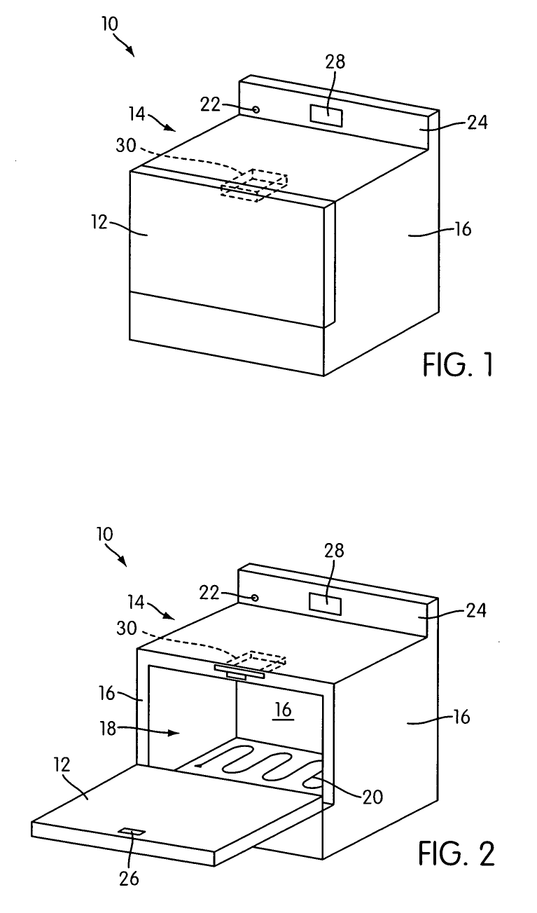

FIG. 1 shows a self-cleaning oven 10 with a door 12 that is hingedly attached to an oven assembly 14. FIG. 2 shows the oven 10 with the door 12 in an open position. The oven assembly 14 includes a plurality of walls 16 that are connected so as to define an internal cavity 18. The cavity 18 includes at least one heating element 20 that is connected to a power source (not shown). The power source may be configured to provide electricity or natural gas for operating the heating element 20. The door 12 allows a person to access the cavity 18 when the door 12 is in an open position, yet provides insulation to the cavity 18 when the door 12 is in a closed position. The door 12 includes an opening 26 that will be discussed in further detail below. The oven assembly 14 also includes an indicator 22 that is disposed on a panel 24, as shown in FIGS. 1 and 2. The indicator 22 will be discussed in further detail below. A temperature input unit 28 is also disposed on the panel. The temperature input unit 28 may be used by the person using the oven 10 to set the desired temperature of the oven 10, as well as initiate a self-cleaning cycle.

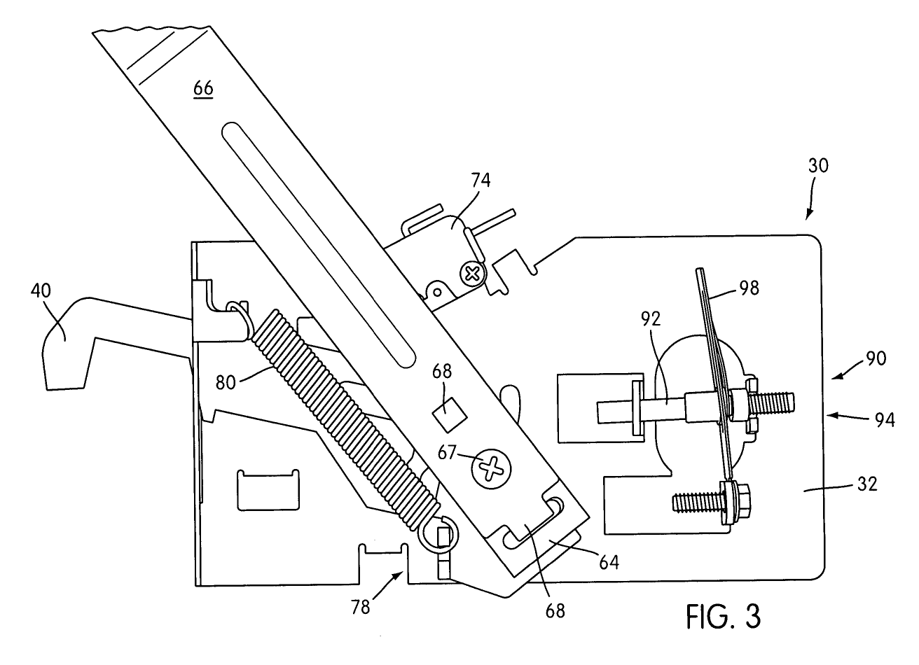

The oven 10 also includes a manual oven door latch assembly 30, which is shown in greater detail in FIG. 3. As shown, the latch assembly 30 includes a base 32. Preferably, the base 32 is attached to a top portion of the oven assembly 14 such that it is located near the opening 26 of the door 12 when the door 12 is in the closed position. The base 32 may be attached to oven assembly 14 with the use of screws, bolts, nuts, rivets or the like (not shown), such that the base 32 is rigidly connected to the oven assembly 14.

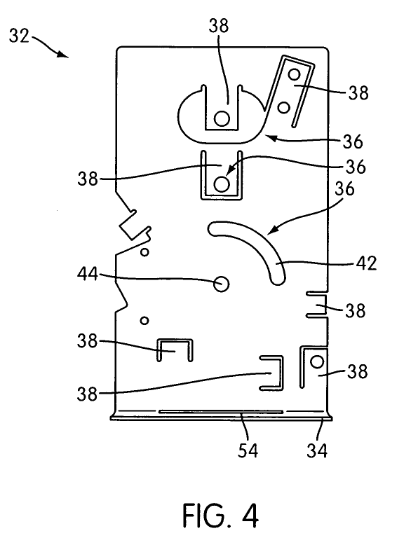

The base 32 is shown in greater detail in FIG. 4. The base 32 is preferably a single piece of substantially rectangular sheet metal that has been bent at one end to form a flange 34, and includes a plurality of stamped openings 36. Of course, it is understood that the base 32 may be of any shape and is not limited to the shape that is shown and described herein. The openings 36 in the base 32 are arranged to receive additional members of the latch assembly 30, which will be described in further detail below. The base 32 may also include a plurality of tabs 38 that may be bent upward or downward from the substantially rectangular surface. The tabs 38 may be used to help attach the base 32 to the oven assembly 14, or to help attach additional members to the base 32. At least two of the openings 36 are used to attach a latch 40 of the assembly 30 to the base 32. Specifically, an arcuate slot 42 and a hole 44 are operatively connected to two openings 46 in the latch 40, as discussed below.

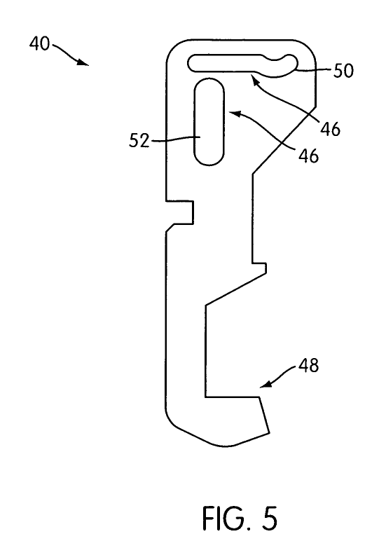

The latch 40, also known in the art as a bolt, is shown in greater detail in FIG. 5. The latch 40 includes a hook 48 at one end, and at least two slots 50, 52 at an opposite end. The hook 48 is designed to be received by the opening 26 in the door 12 so as to latch the door 12 in such a way as to not allow the door 12 to be opened after the latch 40 has been moved to a locked position. The opening 26 in the door 12 is preferably substantially rectangular and is configured to allow the hook 48 to grab onto the door 12, as is known in the art. The at least two slots 50, 52 are operatively connected to the arcuate slot 42 and hole 44, respectively, with known connecting members, such as rivets, bolts, etc. (not shown).

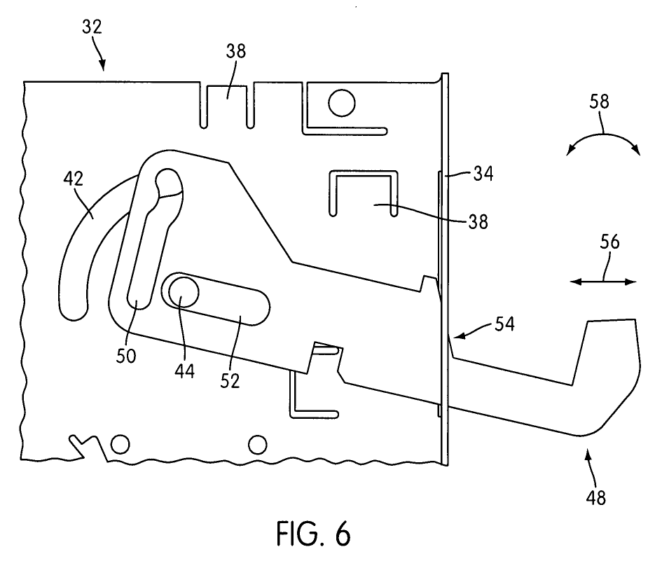

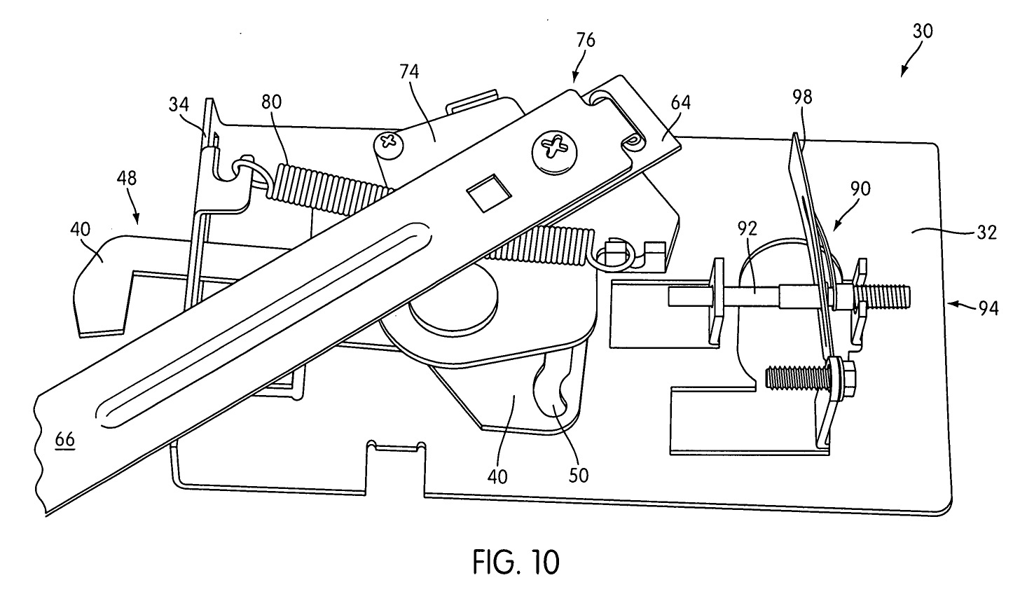

As shown in FIG. 6, the flange 34 of the base 32 includes an opening 54 that allows the latch 40 to extend away from the base 32 in a longitudinal direction 56. The interaction of the arcuate slot 42 of the base 32 and the slot 50 of the latch 40, as well as the interaction of the hole 44 of the base 32 and the slot 52 of the latch 40, allow the latch 40 to move in both a rotational direction 58 and the longitudinal direction 56. Such movement allows the latch 40 to move from an unlatched position 60, shown in FIG. 3, to a latched position 62, shown in FIG. 10. Such interaction of the openings 42, 44 in the base 32 and the openings 50, 52 in the latch 40 provide an assembly with fewer pieces, as compared to assemblies known in the art. Thus, the latch assembly 30 of this embodiment provides a less complex and less expensive construction, with fewer parts being needed for the assembly 30.

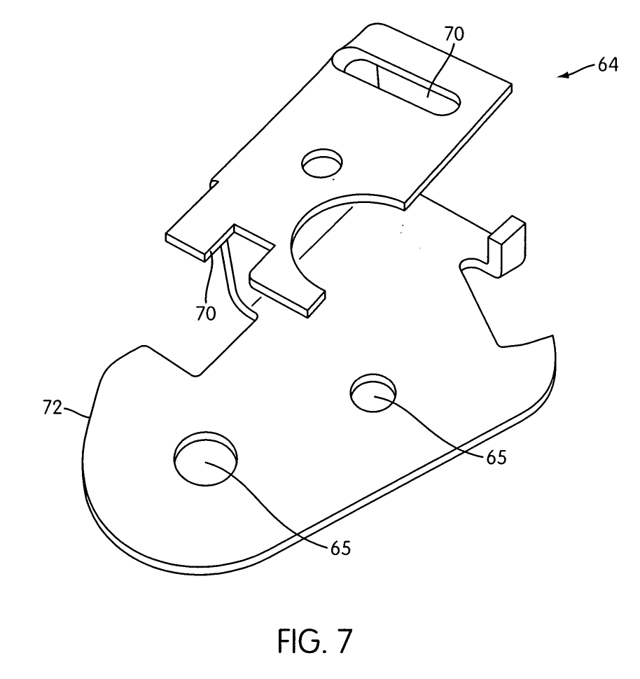

The latch assembly 30 also includes a bracket 64 that is rotatably mounted to the base 32. The bracket 64 is shown in greater detail in FIG. 7. Preferably, the bracket 64 is disposed such that the latch 40 is located in between the bracket 64 and the base 32. As shown, the bracket 64 includes two holes 65 that are arranged to align with the slots 50, 52 of the latch 40 and the arcuate slot 42 and hole 44 of the base 32. This way, as the bracket 64 rotates, the latch 40 moves relative to the base 32 on a path dictated by the interaction of the slots 50, 52, the arcuate slot 42, and the hole 44.

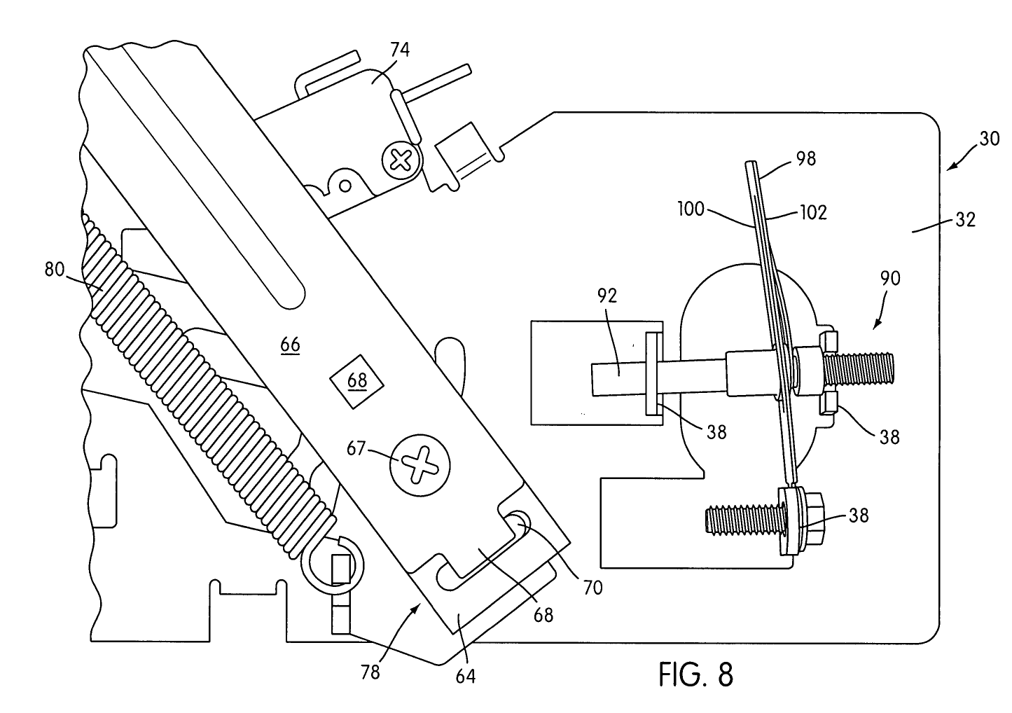

The bracket 64 is constructed and arranged to receive a handle 66, as shown in FIG. 3. The handle 66 is attached to the bracket 64 at one end and extends from the latch assembly 30, and the oven assembly 14, so that a person can grab the handle 66 at a distal end and change the position of the handle 66, in a manner that will be discussed below. The handle 66 is connected to the bracket 64 by known methods, such as with a fastening member 67 and/or mating structures such as tabs 68 and slots 70, as shown in FIG. 8. It is also contemplated that the handle 66 and the bracket,64 may form an integral structure so that the handle 66 is part of the bracket 64. When the handle 66 is moved from one position to another, the bracket 64 will rotate accordingly.

The bracket 64 also includes a cam surface 72, as shown in FIG. 7. The cam surface 72 is arranged to directly contact a switch 74 that is mounted to the base 32. The cam surface 72 is shaped to directly depress the switch 74 when the bracket 64 is rotated to an engaged position 76 and to come out of contact with the switch 74 when the bracket 64 is rotated to a disengaged position 78. This arrangement allows for direct contact so that a switch arm does not have to be disposed in between the switch and bracket, as is common in the art. This arrangement eliminates a piece of the assembly, thereby making the assembly less complex and less expensive to manufacture.

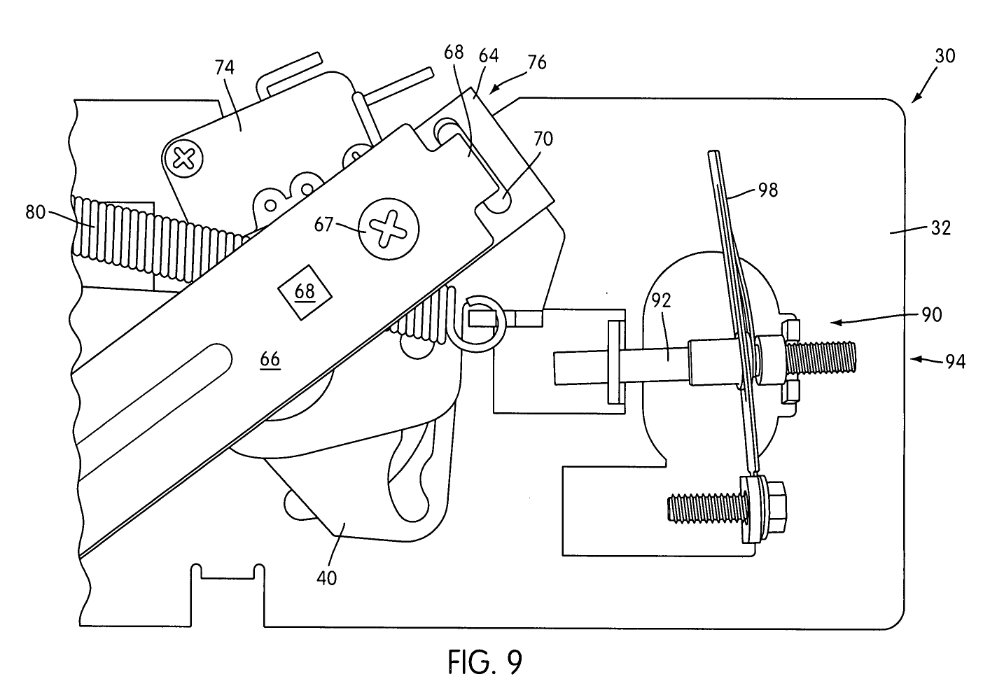

When the bracket 64 is in the engaged position 76, shown in FIG. 9, the switch 74 is depressed, which sends an electrical signal to the indicator 22 on the panel 24 of the oven assembly 14 (FIGS. 1 and 2). The indicator 22 provides a signal to the user that the door 12 of the oven 10 is locked. The indicator 22 is preferably a light, but may be any type of indicator commonly used in the art. When the bracket 64 is in the disengaged position 78, shown in FIGS. 3 and 8, the switch 74 is not depressed and no electrical signal is sent to the indicator 22, thereby indicating that the door 12 is not locked.

Additional members, such as a spring 80 may also be used to assist in the movement of the bracket 64 as the user moves the handle 66 between positions. As shown in the figures, the spring 80 may extend between the flange 34 of the base 12 and the bracket 64 such that the spring 80 is extends further in the unlocked position to thereby assist the handle 66 to be moved in the locked position. In order to unlock the door 12 of the oven, the bias of the spring 80 must be overcome to move the handle 66 in the unlocked position.

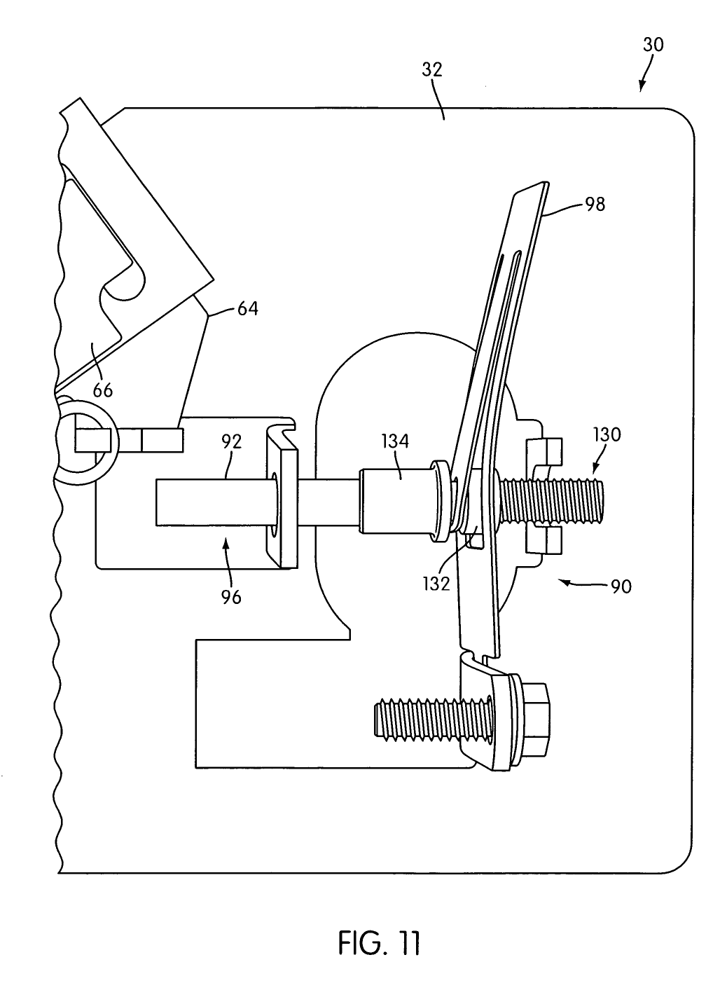

As shown in the figures, a lock 90 for the latch 40 is disposed on the base 32 at an end opposite the flange 34. The lock 90 includes a lock-out member 92 that is mounted to the base 32. The lock-out member 92 may be of any shape, so long as it is capable of moving between a first, unblocking position 94 (FIGS. 9 and 10) and a second, blocking position 96 (FIG. 11). The unblocking position 94 is a position at which the lock-out member 92 does not interfere with the rotation of the bracket 64. The blocking position 96 is a position at which the lock-out member 92 does interfere with the rotation of the bracket 64 and does not allow the bracket 64 to rotate. In the embodiment shown, the lock-out member 92 is attached to the base 32 via the tabs 38 (see FIG. 8) located on the base 32. The tabs 38 are bent upward, away from the surface of the base 32, and include openings that allow the lock-out member 92 slidably move relative to the base 32, preferably in a substantially horizontal relation. Details of the lock-out member 92 will be discussed in further detail below.

The lock 90 also includes a snap-acting blade 98 that is operatively connected to the lock-out member 92. Preferably, the snap blade 98 is disposed substantially perpendicular to the lock-out member 92, as shown in the figures. The snap blade 98 includes at least two different metals that are selected not only for their individual thermal and mechanical properties, but also for their thermal and mechanical properties relative to each other. For example, a first metal 100 is positioned toward the rotating bracket 64, as shown in FIG. 8. A second metal 102 is attached to the first metal 100 such that the two metals together form the snap blade 98. The thermal properties of the second metal 102 are different than the thermal properties of the first metal 100, the implications of which will be discussed below.

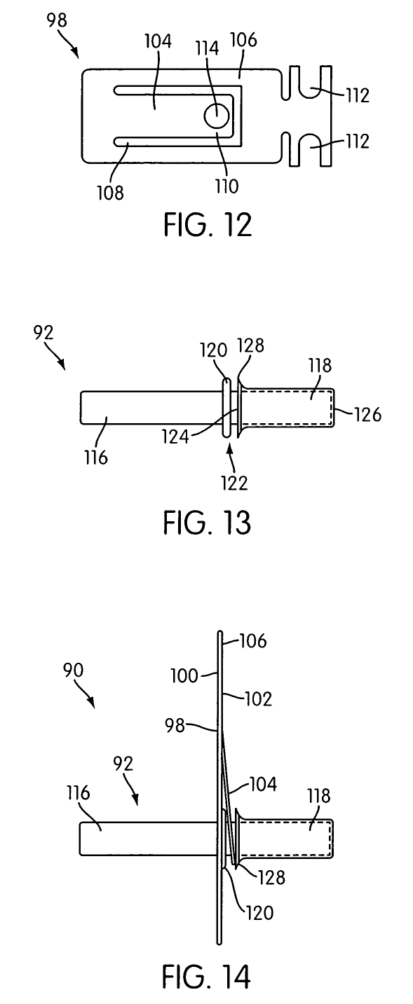

As shown in FIG. 12, the snap blade 98 preferably includes an inner portion 104 and an outer portion 106 that surrounds the inner portion 104. The inner portion 104 is separated from the outer portion 106 on three sides by a continuous slot 108. This configuration allows a free end 110 of the inner portion 104 to move relative to the outer portion 106. The outer portion 106 includes at least one opening 112 that may be used to connect the snap blade 98 to the base 32 at one of the tabs 38. Any suitable connector, such as a fastener or the like may be used to connect the snap blade 98 to the base 32. The inner portion 104 includes an opening 114 that is constructed and arranged to receive the lock-out member 92.

An embodiment of the lock-out member 92, shown in greater detail in FIG. 13, includes a header pin 116 and an eyelet 118 that is configured to receive the header pin 116. The header pin 116 is preferably substantially cylindrical in shape and includes an annular ridge 120 that is disposed in a middle portion 122 of the header pin 116. The eyelet 118 includes an opening 124 that is sized to receive the header pin 116 at one end and a smaller opening 126 at an opposite end. The opening 124 is surrounded by a flange 128. The smaller opening 126 is sized to allow air to flow out of the eyelet 118 as the eyelet 118 is attached to the header pin 116. The opening 114 in the inner portion 104 of the snap blade 98 is sized so that it can be received by the header pin 116, yet cannot move past the ridge 120 or the flange 128. Thus, once the snap blade 98 is mounted to the header pin 116, and the eyelet 118 is then mounted to the header pin 116, the ridge 120 and the flange 128 act to bind the free end 110 of the inner portion 104 of the snap blade 98 such that any lateral movement of the inner portion 104 relative to the outer portion 106 of the snap blade 98 will cause the lock-out member 92 (both the header pin 116 and the eyelet 118) to move. This embodiment of the lock-out member 92 is not intended to be limiting in any way. For example, in an embodiment shown in FIG. 11, the lock-out member 92 includes a threaded portion 130 at one end that receives a nut 132, and a collar 134. The snap blade 98 is held in between the collar 134 and the nut 132 so that the lock-out member 92 moves when the inner portion 104 of the snap blade 98 moves relative to the outer portion 106 of the snap blade 98.

In another embodiment, not illustrated, the lock-out member includes an elongated header pin with integral flanges that are spaced apart so as to receive the inner portion of the snap blade therebetween. In this embodiment, the header pin may have a substantially rectangular, or square, cross-section, and the flanges may extend from only two opposing sides of the header pin. Similarly, the opening in the inner portion of the snap blade may have an irregular shape so that upon assembly, one of the flanges of the lock-out member may pass through the snap blade. The lock-out member may then be rotated so the snap blade is contained between the flanges, and the snap blade and lock-out member interact with one another as described herein.

In the illustrated embodiment, the lock-out member 92 is positioned on the base 32 so that the snap blade 98 is slightly bent towards the bracket 64 when the oven is below a predetermined temperature. In this configuration, the free end 110 of the inner portion 104 of the snap blade 98 is pulled away from the outer portion 106 in a direction away from the bracket 64, as shown in FIGS. 8-10. This positions the lock-out member 92 in the unblocking position 94.

The thermal properties of the first and second metals 100, 102 of the snap blade 98 are such that until the temperature of the oven 10 exceeds the predetermined temperature, the free end 110 of the inner portion 104 of the snap blade 98 will not substantially move. That is, the free end 110 of the inner portion will not move through the outer portion 106, but will remain on the side of the snap blade 98 that is away from the bracket 64. As a result, the lock-out member 92 will not substantially move. As the temperature in the oven 10 increases, the first metal 100 will expand at a greater rate than the second metal 102, thereby causing the outer portion 106 of the snap blade 98 to straighten from its initial bent position. This straightening is caused by having one end of the outer portion 106 fixed and allowing the opposite end to rotate relative to the fixed end.

When the temperature of the oven 10 reaches the predetermined temperature, the snap blade 98 will be in a substantially straight configuration, as shown in FIG. 14. Just as the temperature exceeds the predetermined temperature, the outer portion 106 of the snap blade will continue to rotate in a direction away from the bracket 64 due to the thermal properties of the first and second metals 100, 102. This further movement causes the snap blade 98 to “snap,” and the free end 110 of the inner portion 104 of the snap blade 98 moves through the outer portion 106, in a direction toward the bracket 64, thereby affecting movement of the lock-out member 92. This causes the lock-out member 92 to move toward the bracket 64 (towards the left in FIGS. 9-11) and into the blocking position 96. When the lock-out member 92 is in the blocking position 96, it is disposed in a position that will interfere with movement of the bracket 64 so that the bracket 64 is unable to rotate out of its engaged position 76. The snap blade 98 and lock-out member 92 will remain in this position until the temperature decreases below the predetermined value. The predetermined value is typically between about 525° F. and about 600° F. More preferably, the predetermined value is between about 540° F. and about 575° F. Most preferably, the predetermined value is about 550° F.

By having the lock-out member 92 actuated into the blocking position 96 via the snap blade 98, the problems of nuisance lock-out can be avoided because movement of the lock-out member 92 is relatively sudden, rather than progressive, and will not move to block movement of the bracket until the temperature exceeds the predetermined value, which is above the typical baking temperature used in the oven 10. Otherwise stated, the lock-out member 92 is instantly moved to the blocking position rather than progressively moved.

In operation, when the user of the oven 10 would like to clean the oven 10, the user moves the handle 66 of the latch assembly 30 to the locked position, as shown in FIG. 10. Movement of the handle 66 causes the bracket 64 to rotate, which allows the cam surface 72 to engage the switch 74 directly (without the use of a switch arm). Activation of the switch 74 causes the indicator 22 to indicate that the door 12 is locked. As the handle 66 is moved, the latch 40 moves both in the rotational direction 58 and the longitudinal direction 56 such that the hook 48 engages the door 12 via the opening 26. This prevents the door 12 from being opened without further action by the user. The user may then set the temperature input unit 28 to start the self-clean cycle.

As the temperature in the oven cavity 18 increases, the user is still able to unlock the door 12 by moving the handle 66 to the unlocked position, as shown in FIG. 3. However, once the temperature in the cavity 18 of the oven 10 reaches the predetermined level, e.g. about 550° F., the snap blade 98 snaps, as shown in FIG. 11, thereby moving the lock-out member 92 to its blocking position 96. Such movement prevents the bracket 64 from being able to rotate, which locks the handle 66 in place.

After the self-cleaning cycle is over and the temperature within the cavity 18 is reduced to a temperature below the predetermined level, the snap blade 98 snaps back to its original position, which moves the lock-out member 92 to its unblocking position 94. It should be appreciated, however, that in one embodiment, the return of the lock-out member 92 to the unblocking position 94 may be a progressive movement and need not necessarily be with a snapping action. The bracket 64 is no longer blocked, and the handle 66 may now be returned to its unlocked position. Movement of the handle 66 to its unlocked position moves the latch 40 both in the longitudinal direction 56 and the rotational direction 58, thereby allowing the latch 40 to disengage from the door 12. The cam surface 72 of the bracket 64 moves so that it disengages from the switch 74. The indicator 22 then indicates that the door 12 is unlocked. The oven 10 is now ready to be used in its normal capacity.

While preferred embodiments of the invention have been shown and described, it is evident that variations and modifications are possible that are within the spirit and scope of the preferred embodiments described herein. The disclosed embodiments have been provided solely to illustrate the principles of the invention and should not be considered limiting in any way.

1. A latch lock assembly for a door of a self-cleaning oven, the assembly comprising:
a base for mounting the assembly to the oven;
a latch operatively connected to the base at a first portion and configured to engage the door of the oven at a second portion, the latch being moveable between a released position and an engaged position;
a bracket operatively connected to the latch so as to effect movement of the latch between the released position and the engaged position when the bracket is rotated;
a lock-out member moveably carried by the base and configured to be movable between an unblocking position and a blocking position; and
a snap-acting blade operatively connected to the lock-out member, the blade configured to remain in a first position when a temperature within the oven is less than a predetermined level, thereby holding the lock-out member in the unblocking position, and the blade configured to snap into a second position when the temperature exceeds the predetermined level, thereby causing the lock-out member to move into the blocking position,
the bracket being unable to rotate when the lock-out member is in the blocking position.

2. The assembly of claim 1, wherein the lock-out member moves substantially parallel to the base when moving between the unblocking position and the blocking position.

3. The assembly of claim 1, wherein the snap-acting blade comprises at least two metals having different thermal properties.

4. The assembly of claim 1, wherein the snap-action blade comprises an inner portion operatively connected to the lock-out member and an outer portion operatively connected to the base, the inner portion being moveable relative to the outer portion.

5. The assembly of claim 1, wherein the predetermined temperature is between about 525° F. and about 600° F.

6. The assembly of claim 5, wherein the predetermined temperature is between about 540° F. and about 575° F.

7. The assembly of claim 6, wherein the predetermined temperature is about 550° F.

8. The assembly of claim 1, wherein the snap-acting blade is disposed substantially perpendicular to the lock-out member.

9. The assembly of claim 1, further comprising a switch electrically connected to the oven, the switch being constructed and arranged to indicate at least two positions of the latch relative to the door.

10. The assembly of claim 9, wherein the at least two positions of the latch comprises an unlatched position and a latched position.

11. The assembly of claim 9, wherein the bracket comprises a cam, the cam being in direct contact with the switch when the bracket is rotated to a position that corresponds to the engaged position of the latch.

12. The assembly of claim 1, wherein the first end of the latch comprises a first slot and a second slot that is substantially perpendicular to the first slot.

13. The assembly of claim 12, wherein the base comprises a first opening and a second opening, the first opening being operatively connected to the first slot of the latch and the second opening being operatively connected to the second slot of the latch.

14. The assembly of claim 13, wherein the first opening of the base comprises an arcuate slot.

15. The assembly of claim 14, wherein the second opening of the base comprises a hole.

16. The assembly of claim 1, further comprising a handle operatively connected to the bracket, wherein a distal end of the handle is configured to be received by a person.

17. The assembly of claim 1, wherein the bracket comprises an integral handle portion with a distal end configured to be received by a person.

18. An self-cleaning oven comprising:
a door hingedly mounted to a main oven assembly; and
a latch lock assembly operatively connected to the door so as to lock the door when the oven is in self-cleaning mode, the latch lock assembly comprising a base for mounting the latch lock assembly to the main oven assembly;
a latch operatively connected to the base at a first portion and configured to engage the door of the oven at a second portion, the latch being moveable between a released position and an engaged position;
a bracket operatively connected to the latch so as to effect movement of the latch between the released position and the engaged position when the bracket is rotated;
a lock-out member moveably carried by the base and configured to be movable between an unblocking position and a blocking position; and
a snap-acting blade operatively connected to the lock-out member, the blade configured to remain in a first position when a temperature within the oven is less than a predetermined level, thereby holding the lock-out member in the unblocking position, and to snap into a second position when the temperature exceeds the predetermined level, thereby causing the lock-out member to move into the blocking position,
the bracket being unable to rotate when the lock-out member is in the blocking position.

19. The oven of claim 18, wherein the lock-out member moves substantially parallel to the base when moving between the unblocking position and the blocking position.

20. The oven of claim 18, wherein the snap-acting blade comprises at least two metals having different thermal properties.

21. The oven of claim 18, wherein the snap-acting blade comprises an inner portion operatively connected to the lock-out member and an outer portion operatively connected to the base, the inner portion being moveable relative to the outer portion.

22. The oven of claim 18, wherein the predetermined temperature is between about 525° F. and about 600° F.

23. The oven of claim 22, wherein the predetermined temperature is between about 540° F. and about 575° F.

24. The oven of claim 23, wherein the predetermined temperature is about 550° F.

25. The oven of claim 18, wherein the snap-acting blade is disposed substantially perpendicular to the lock-out member.

26. The oven of claim 18, wherein the latch lock assembly further comprises a switch electrically connected to a panel of the oven assembly, the switch constructed and arranged to indicate at least two positions of the latch relative to the door.

27. The oven of claim 26, wherein the at least two positions of the latch comprises an unlatched position and a latched position.

28. The oven of claim 26, wherein the bracket comprises a cam, the cam being in direct contact with the switch when the bracket is rotated to a position that corresponds to the engaged position of the latch.

29. The oven of claim 18, wherein the first portion of the latch comprises a first slot, and a second slot that is substantially perpendicular to the first slot.

30. The oven of claim 29, wherein the base comprises a first opening and a second opening, the first opening being operatively connected to the first slot of the latch and the second opening being operatively connected to the second slot of the latch.

31. The oven of claim 30, wherein the first opening of the base comprises an arcuate slot.

32. The oven of claim 31, wherein the second opening of the base comprises a hole.

33. The oven of claim 18, wherein the latch assembly further comprises a handle operatively connected to the bracket, the handle comprising a distal end configured to be received by a person.

34. The oven of claim 18, wherein the bracket comprises an integral handle portion with a distal end configured to be received by a person.
